(19) United States
(12) Patent Application Publication
(10) Pub. No.: US 2005/0071229 A1
(43) Pub. Date: Mar. 31, 2005

(54) System and method for permitting the secure creation, distribution, tracking, and redemption of payments to a customer

(76) Inventors: Alex Mashinsky, New York, NY (US); Patrick Questembert, New York, NY (US)

Correspondence Address: COHEN, PONTANI, LIEBERMAN & PAVANE, 551 FIFTH AVENUE, SUITE 1210, NEW YORK, NY, 10176, US

(21) Appl. No.: 10/953,927

(22) Filed: Sep. 29, 2004

Related U.S. Application Data
(60) Provisional application No. 60/507,186, filed on Sep. 30, 2003.

(51) Int. Cl. G06F 17/60

(52) U.S. Cl. 705/14

(57) ABSTRACT

A system and method for permitting the secure creation, distribution, tracking, and redemption of payments, i.e., cash stamps, from a business to a consumer, wherein cash stamps are distributed in a variety of methods, such as email and/or short message service (SMS) messages. Businesses can purchase blocks of cash stamps having a desired monetary value and distribute the cash stamps to consumers. The consumers that receive the cash stamps may then redeem them for payment, e.g. for cash, goods, or discounts on goods and services, or the like.

### RELATED APPLICATIONS

The present application claims priority from U.S. Provisional Patent Application Ser. No. 60/507,186 filed Sep. 30, 2003.

### BACKGROUND OF THE INVENTION

1. Field of the Invention

The present invention generally relates to on-line advertising and, more particularly, to a system and method for permitting the secure creation, distribution, tracking, and redemption of payments to a customer.

2. Description of the Related Art

In the last several years, an explosive growth in the content and services available on the Internet has occurred. As a result, it has become difficult for businesses to find effective ways to gain the attention of consumers on the Internet. Despite these challenges, businesses are willing to pay for the attention and business of consumers, as evidenced by their purchase of advertising and the prevalence of coupons and rebates offered to consumers. However, consumer incentives and advertising are not as effective on the Internet. This may be due to the deficiencies of the current options and methods for gaining the attention of consumers actively surfing the Internet.

A common method that is used for Internet advertising is banner advertisements. When initially introduced, these types of advertisements generated high click-through rates. However, consumers have become used to banner ads. As a result, click-through rates have fallen to a level that is now typically below 0.5%. The effectiveness of commercial email, especially unsolicited commercial email, i.e., “spam,” is also low. This is due primarily to the sheer volume of email messages that are transmitted over the Internet. According to a study published by the Interactive Data Corporation (IDC), 31 billion email messages per day were sent in 2002, with a forecasted increase to 60 billion per day by the year 2006. Here, spam will make up a large percentage of the emails sent. The ineffectiveness of commercial email is also due to the current difficulties associated with differentiating between different types of email. Another contributing factor is that no incentive or value is provided to the consumer to read commercial email.

Various systems and methods have been proposed that would permit payments of small amounts of cash between businesses and consumers, while exhibiting low transaction costs. Traditionally, schemes for both micro-payments and electronic cash have suffered from various deficiencies.

Micro-payments were invented primarily as a mechanism for allowing consumers to make small payments to businesses in return for content (e.g., $0.05 for an article). Given the prevalence of free content on the Internet, consumers do not readily accept the need to pay for content. In addition, consumers are adverse to signing up for such a service (which typically requires that the consumer provide certain financial billing details) without some reassurance that they would use the micro-payment service frequently, and that the service would last. Consumers are aware that several different services have been built, but are no longer in existence. Generally, the few content providers that are able to charge for content have done so on a more traditional subscription basis.

There is a low acceptance rate of electronic cash schemes. Generally, this is caused by the high complexity of the particular service. In an electronic world, replicating cash and its characteristics (e.g., anonymous, and accepted everywhere) requires sophisticated technology and encryption, which implies large technology and usability hurdles.

Given the deficiencies of the prior “schemes” and low level of market acceptance thereof, there is a need for a system and method for permitting businesses to pay consumers for their attention and business.

### SUMMARY OF THE INVENTION

The invention is a system and method for permitting the secure creation, distribution, tracking, and redemption of payments, i.e., stamps, from a business to a consumer. In accordance with the invention, the stamps may be distributed in a variety of methods, such as email and/or short message service (SMS) messages. Here, businesses can purchase blocks of stamps having a desired monetary value, and distribute the stamps to consumers. The consumers that receive the stamps may then redeem them for payment (e.g., for cash, goods, or discounts on goods, or the like). In an embodiment of the invention, restrictions on the redemption of the stamps are set, such as a time limit or expiration date, or an activity that must be performed, such as visiting a website in order to redeem the stamps.

As used herein, “cash stamp” refers to a stamp that a consumer may acquire and redeem for a reward, which is typically in the form of cash, goods, services, and/or discounts on goods or services.

A business is the purchaser of a cash stamp. In accordance with the invention, the term “business” is used to differentiate it from the receiver of the cash stamp. However, the purchaser of the cash stamp is not required to be a business. Here, the purchaser could be any one of a variety of entities, such as a business, a corporation and/or an individual. A consumer is the receiver of a cash stamp. In certain embodiments of the invention, a consumer may be a business or an individual.

Thus, businesses would offer cash stamps to consumers, who could then redeem the cash stamps for rewards.

Cash stamps are issued by a centralized entity called a Stamps Clearinghouse. Each cash stamp represents a reward value that is guaranteed by the Stamps Clearinghouse. In accordance with the invention, a cash stamp is comprised of a sequence of bits guaranteeing it was issued by the Stamps Clearinghouse, and uniquely identifying it from any other stamp issued by the Stamps Clearinghouse. In contemplated embodiments of the invention, the number of bits in each stamp (e.g. 256 bits) is a function of the implementation of the Stamps Clearinghouse and depends on the attributes of the cash stamps supported by the Stamps Clearinghouse. In accordance with the contemplated embodiments, the attributes include the period in which the cash stamps will expire, information about the entity that purchased the stamp, or a certain activity which has to take place to redeem the stamp, or the like. In additional embodiments, the cash stamp contains a hash of itself, digitally signed by the Stamps Clearinghouse, which guarantees its integrity and authenticity. A hash is created when a string of characters is transformed into a shorter fixed-length value or key that represents the original string (i.e., hashing). This technique can be used to index and retrieve items in a database because it is faster to find the item using the shorter hashed key than to find it using the original value. Hashing is also used in many encryption algorithms.

In accordance with invention, the cash stamps are redeemable for payment with the Stamps Clearinghouse that issues and manages cash stamps or with another party that has a relationship with the Stamps Clearinghouse, such as an Internet Service Provider (ISP).

In an embodiment of the invention, a business purchases a cash stamp from the Stamps Clearinghouse and sends it via email to a consumer. After receiving the email with the attached cash stamp, the consumer's ISP validates the authenticity of the cash stamp and delivers the email to the consumer. After the consumer opens the email, the consumer's ISP credits the consumer's balance at the ISP, decreasing the consumer's monthly bill.

In an embodiment of the invention, the consumer's ISP may also verify the identity of the e-mail's sender by comparing it to the sender indicated within the cash stamp. As a result the prevention of “spoofing” is achieved. In spoofing a sender may manipulate an e-mails such that it appears to originate from another sender and thus, help him to bypass black-list mechanisms and other anti-spam techniques. In accordance with the contemplated embodiments, the sender verification may be performed independently by the consumer's ISP, or at the request of the consumer's ISP by the Stamps Clearinghouse.

In an alternative embodiment of the invention, the Stamps Clearinghouse provides consumers with an implicit indication that the sender is legitimate and adheres to a specified set of “best” practices. For example, the Stamps Clearinghouse may issue stamps only to senders who commit to honoring unsubscribe requests.

An ISP is the recipient of an e-mail possibly containing a cash stamp. In accordance with the invention, the term “ISP” is used to describe the entity that will identify e-mails containing cash stamps, verify the authenticity of cash stamps, as well as process, redeem and transform the cash stamps so as to differentiate them from the ultimate beneficiary of the cash stamp, i.e. the consumer, who will enjoy the ownership and use of the cash stamp. However, the entity verifying and processing the cash stamp is not required to be a business. Here, the verification and processing could be performed directly on the device used by the consumer to receive the cash stamp, such as a cell phone receiving a cash stamp via SMS, a consumer PC accessing a web page with a cash stamp. Alternatively, when the consumer's PC is accessing e-mail, the cash stamp may be processed on the consumer's PC by way of client-side components.

In accordance with the contemplated embodiments of the invention, the consumer has the option to redeem the cash stamps for goods or services, and/or discounts on goods or services. Here, the consumer's accounts are credited with points in exchange for the value of the cash stamp. At the option of the consumer, the points may be redeemed in return for consumer goods, or the consumer may opt to receive vouchers which provide discounts on the goods and/or services.

### BRIEF DESCRIPTION OF THE DRAWINGS

The foregoing and other advantages and features of the invention will become more apparent from the detailed description of the exemplary embodiments of the invention given below with reference to the accompanying drawings in which:

FIG. 1 is a block diagram illustrating the entities involved during a normal transaction when the consumer's ISP has a relationship with a Stamps Clearinghouse in accordance with the invention;

FIG. 2 is a block diagram illustrating the entities involved during a normal transaction when the consumer's ISP does not have a relationship with the Stamps Clearinghouse;

FIGS. 3 and 4 are illustrations of situations where invalid cash stamps have been identified;

FIG. 5 is a block diagram illustrating the entities involved when a consumer is sent two cash stamps with two separate activities required in accordance with the invention;

FIG. 6 is a block diagram illustrating the entities involved during a normal transaction when the consumer's ISP has a relationship with the Stamps Clearinghouse of FIG. 1, and the Stamps Clearinghouse sends an email to the consumer's ISP in accordance with the invention;

FIG. 7 is a block diagram illustrating the entities involved during a normal transaction utilizing short message service (SMS) messaging when the consumer's wireless company has a relationship with the Stamps Clearinghouse in accordance with the invention; and

FIG. 8 is a block diagram illustrating the entities involved during a normal transaction from a consumer to a business, conducted through IP enabled phones or the like in accordance with the invention.

### DETAILED DESCRIPTION OF THE EXEMPLARY EMBODIMENTS

The present invention is a system and method for permitting the secure creation, distribution, tracking, and redemption of payments, i.e., cash stamps, from a business to a consumer. Cash stamps provide an easy way to send payments of any amount between a business and a consumer when a pre-existing relationship between the two does not exist. This permits the business to gain the attention of consumers, where the consumers are specifically targetable to thereby allow them to monetize (i.e., assign a monetary value) the attention that they pay to a particular item. In accordance with the invention, these consumers can be compensated based on their specific characteristics. As a result, businesses are provided with a way to obtain valuable contacts.

Consumers that receive the cash stamps may redeem them for payment in the form of goods, services, cash, and/or discounts on goods or services. In certain embodiments of the invention, restrictions on the redemption of the cash stamp are set, such as a time limit or expiration date. Here, the cash stamp would need to be redeemed within a certain amount of time to receive their full value. In an additional embodiment of the invention, the cash stamps have a declining or zero value after they expire. In accordance with the present contemplated embodiments, having an expiration date permits businesses to ensure that their obligations to the Stamps Clearinghouse are fulfilled within a fixed period of time. In addition, consumers are encouraged to quickly perform whatever activity is required in order to redeem the cash stamp. As a result, an interaction is achieved with the consumer that is richer than the interaction provided by a simple advertisement. In an embodiment of the invention, the restriction on the redemption of the cash stamp is an integrated activity that must be performed, such as opening an email or visiting a website to redeem the cash stamp. In another embodiment, the activity is one activity that is separate from the redemption process, such as viewing as a flash advertisement. In accordance with the contemplated embodiments of the invention, the consumer has the option to redeem the cash stamps for goods or services, or discounts on good or services, or the like. Here, the consumer's accounts are credited with points in exchange for the value of the cash stamp. At the option of the consumer, the points may be redeemed in return for consumer goods, or the consumer may opt to receive vouchers which are redeemable for discounts on goods and/or services.

In order to acquire a cash stamp, a business must interact with a Stamps Clearinghouse. In accordance with the invention, the business and Stamps Clearinghouse are separate entities. In the contemplated embodiments of the invention, however, the business and the Stamps Clearinghouse can be a single entity.

In accordance with the invention, the business may pre-pay for the cash stamps, post-pay for the stamps, or pay for the cash stamps in real-time, i.e., when each cash stamp is redeemed. In cases where post payment for the cash stamp occurs, the payment amount is covered by the Stamps Clearinghouse. In either scenario, the Stamps Clearinghouse guarantees the amount paid to the consumer. In the contemplated embodiments of the invention, the actual amount paid from the business to the Stamps Clearinghouse may be based on several factors. In one embodiment, the Stamps Clearinghouse requires payment for the full value of all of the cash stamps. Here, the un-redeemed cash stamps are redeemed after the expiration of a predetermined time period. In an alternative embodiment, the payment of a portion of the full value of the purchased cash stamps is required.

After the business has acquired the cash stamps, they are attached to electronic messages that are subsequently sent to consumers in a manner well known in the art. In alternative embodiments, the businesses supply the consumer addresses and messages for delivery to the Stamps Clearinghouse. The messages are then forwarded to the addresses of the consumer from the Stamps Clearinghouse. In accordance with the contemplated embodiments of the invention, the cash stamps are attacheable to a variety of messages, such as email, SMS, instant messages, or the like.

When the cash stamp is sent to the consumer, intermediate parties that handle the message, such as the consumer's ISP, may receive a portion of the cash stamp as payment for their services. In accordance with the invention, this may be accomplished via a “swap” service, i.e., an entity that allows a party to cash-in a stamp while receiving a new stamp in exchange. As a result, the party is permitted to redeem a portion of a cash stamp for cash, while obtaining a new cash stamp with the same attributes but with a monetary value decreased by the percentage or fixed amount that was paid to the entity. For example, the present invention allows an ISP to present a $0.75 cash stamp to the Stamps Clearinghouse, request to claim $0.05 (e.g., a processing fee), and receive in exchange a new stamp worth $0.70.

When a consumer receives the message, if their ISP operates with the Stamps Clearinghouse, then the ISP would recognize that a cash stamp is attached. In accordance with the invention, the ISP would then verify the validity of the cash stamp by querying the Stamps Clearinghouse. If the cash stamp is valid, then the ISP marks the email to indicate that it contains a valid cash stamp. As a result, when viewing incoming emails, the consumer is provided with an indication that permits him to easily recognize that the email contains a cash stamp.

In accordance with the invention, the validity of the cash stamp is communicated to consumers in various ways. In certain embodiments of the invention, the validity of the cash stamp is verified by adding a new email property, e.g., a green flag on the consumer's screen next to the corresponding email, sending an additional email noting the validity of the stamp, adding lines to the subject line of the email to notify the consumer as to the validity of the stamp, or by sending a different type of message to thereby notify the consumer as to the validity of the stamp, e.g., sending an instant message.

In accordance with the invention, the ISP will deliver the message without an attached cash stamp if the cash stamp is invalid. In certain embodiments, the ISP will notify the consumer as to the presence of an invalid cash stamp. In other embodiments, the message containing the invalid cash stamp is completely discarded.

In accordance with the invention, the ISP establishes a way to allow the consumer to redeem the cash stamp for cash. Here, the ISP will redeem the cash stamp, based upon the requirements of the cash stamp, as soon as the consumer opens the email message. In certain embodiments, alternative redemption methods are used, such as an ISP to insert a URL into the email that invokes a function on the ISP's site to process the stamp. When the consumer opens this email and clicks on the enclosed URL, the ISP will proceed to “cash-in” the stamp on behalf of the consumer and credit the customer's account at the ISP by the value of the cash stamp. Here, it should be noted that the value credited is minus any possible processing fees charged by the ISP. The present invention advantageously eliminates the need for consumers to have a relationship (i.e. an account) with the Stamps Clearinghouse. Instead, the ISP simply credits the consumer's account at the ISP.

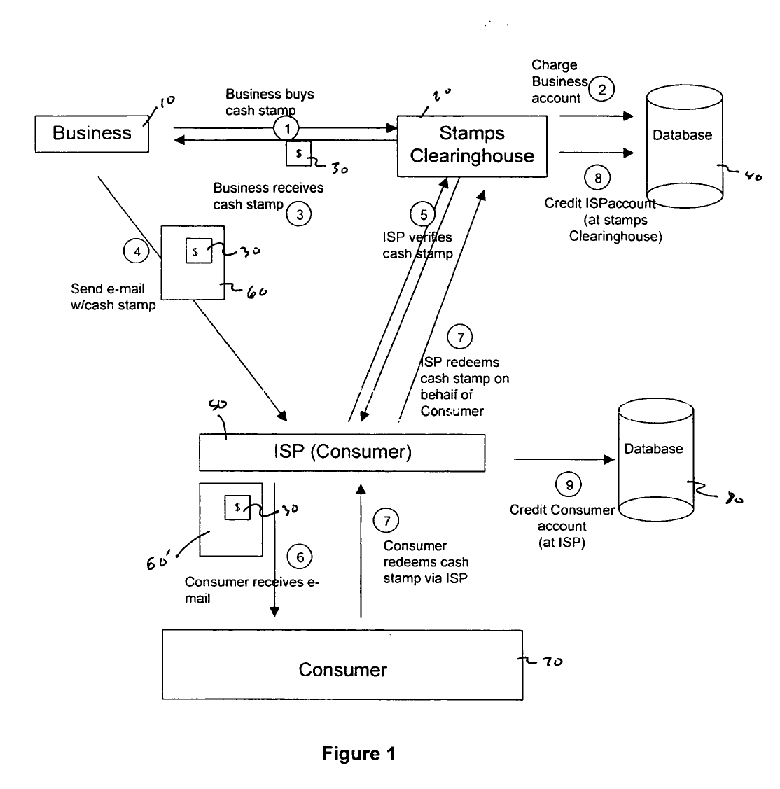

With reference to FIG. 1, shown therein is a block diagram illustrating the entities involved during a normal transaction when the consumer's ISP has a relationship with the Stamps Clearinghouse. With reference to FIG. 1, the method of the invention is implemented when a business 10 accesses the Stamps Clearinghouse 20 to purchase a cash stamp 30, as indicated in step 1. In the preferred embodiment, the business is an advertiser.

Next, the Stamps Clearinghouse 20 charges the business' account that is located in the database 40 for the value of the cash stamp 30, as indicated in step 2. The Stamps Clearinghouse 20 then forwards the cash stamp 30 to the business, as indicated in step 3.

Upon receipt of the cash stamp 30 from the Stamps Clearinghouse 20, the business 10 attaches the cash stamp 30 to an email 60 that is then sent to a consumer's ISP 50, as indicated in step 4. Here, the ISP 50 receives the email 60 and queries the Stamps Clearinghouse to verify that the attached cash stamp 30 is valid, as indicated in step 5.

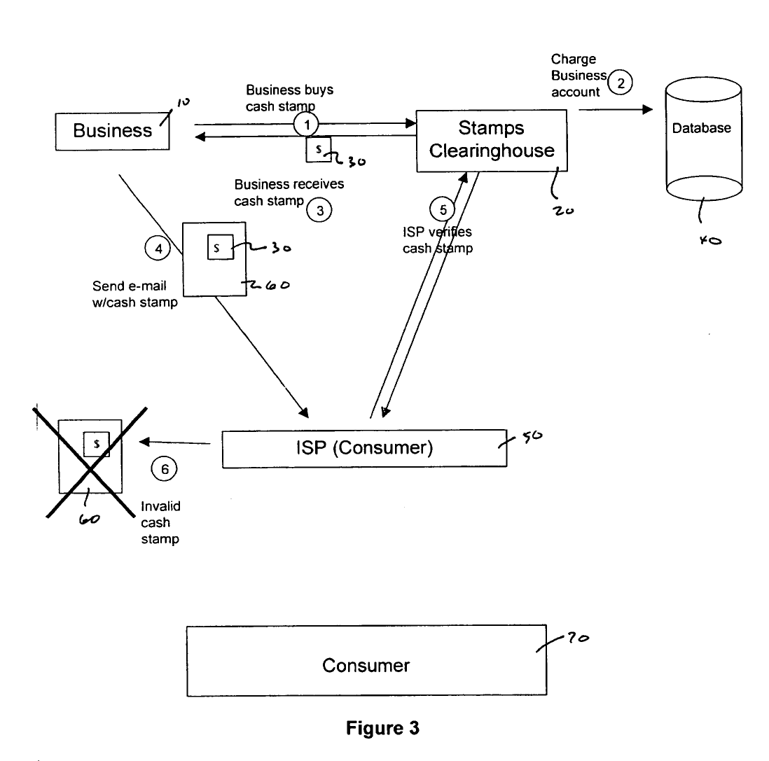

If the cash stamp 30 is valid, then the email is “flagged” as containing the cash stamp 30 and a flagged email 60′ is forwarded to the consumer 70, as indicated in step 6. In accordance with the invention, the ISP will deliver the message without an attached cash stamp if the cash stamp is invalid. In certain embodiments, the ISP will notify the consumer as to the presence of an invalid cash stamp (see FIG. 3). In other embodiments, the message containing the invalid cash stamp is completely discarded. At this stage, the flagged email 60′ is opened by the consumer 70, where the consumer's ISP 50 is notified that the consumer 70 has read the email. Next, the consumer 70 can redeem the cash stamp 30 at the Stamps Clearinghouse 20 via the ISP 50, as indicated in step 7.

When the cash stamp 30 is presented for redemption at the Stamps Clearinghouse 20, the value of the cash stamp 30 is credited to the consumer's ISP account that is located in the database 40 at the Stamps Clearinghouse 20, as indicated in step 8. In addition, the consumer's ISP 50 credits the value of the cash 30 stamp to the consumer's account that is located in the database 80, as indicated in step 9.

In cases where consumers have an ISP that does not support cash stamps, the consumers may have previously downloaded an email client add-on component which ties in with their email software, such as a Microsoft Outlook add-on. In accordance with the invention, the email client add-on will check all incoming emails for the presence of cash stamps. For each email containing a cash stamp, the email client add-on will check the validity of the cash stamp. As a result, the email client add-on will remove the cash stamp from the email if the stamp is not valid, and either notify the consumer or discard the mail. Otherwise, the consumer will be notified to indicate the presence of a valid cash stamp even before the consumer opens the email. In the preferred embodiment of the invention, a flag is attached to the email to notify the consumer that the valid cash stamp is present. This advantageously works for all consumers who download the email client add-on, without requiring the ISP to assist in handling the cash stamps. The drawback, however, is that when a consumer opens an email with an attached cash stamp, in order to redeem the stamps for cash, he needs to interact with the Stamps Clearinghouse. In addition, the consumer must posses an account with the Stamps Clearinghouse where he may redeem the cash stamps for cash. This entails registering with the Stamps Clearinghouse and providing financial references, such as a bank account, credit card or an on-line electronic payment provider such as PayPal, Bidpay, or the like. If the consumer does not wish to download an email-client add-on, the consumer may need to register with the Stamps Clearinghouse to redeem the cash stamp without having any assurance that it is valid.

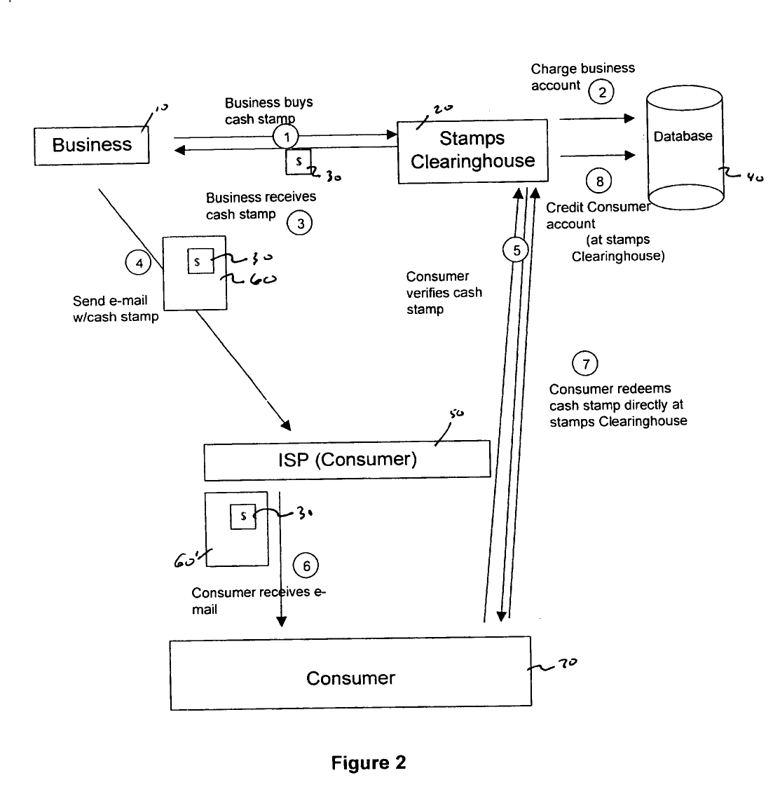

FIG. 2 is a block diagram illustrating the entities involved during a normal transaction when the consumer's ISP does not have a relationship with the Stamps Clearinghouse. Here, the method of the invention is implemented when a business 10 accesses the Stamps Clearinghouse 20 to purchase a cash stamp 30, as indicated in step 1. In the preferred embodiments, the business is an advertiser.

The Stamps Clearinghouse 20 charges the account of the business 20 that is located in the database 40 for the value of the cash stamp 30, as indicated in step 2.

Next, the Stamps Clearinghouse 20 sends the cash stamp 30 to the business 10, as indicated in step 3. The business 10 attaches the cash stamp 30 to an email 60 and forwards the email containing the cash stamp to the consumer's ISP 50, as indicated in step 4.

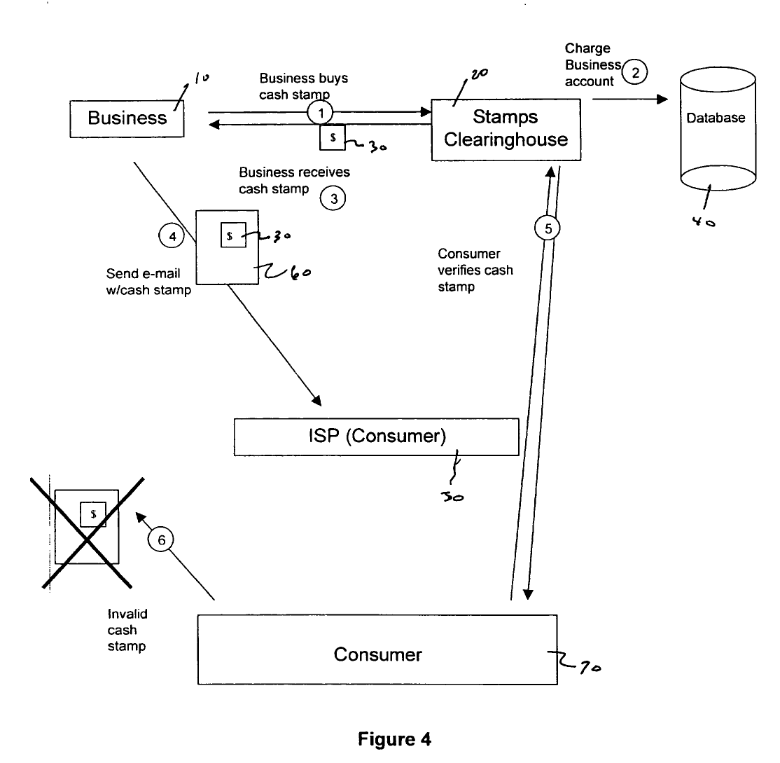

The consumer 70 receives the email 60 and verifies that a cash stamp 30 is attached to the email, as indicated in step 5. The consumer 70 also verifies that the cash stamp 30 is valid, as indicated in step 6. In accordance with the invention, the ISP will deliver the message without an attached cash stamp if the cash stamp is invalid. In certain embodiments, the ISP will notify the consumer as to the presence of an invalid cash stamp (see FIG. 4). In other embodiments, the message containing the invalid cash stamp is completely discarded. At this stage, the consumer 70 has the option to directly redeem the valid cash stamp 30 at the Stamps Clearinghouse 20, as indicated in step 7.

After the consumer 70 redeems the cash stamp 30, the Stamps Clearinghouse 20 credits the value of the cash stamp 30 to the consumer's account that is located in database 40, as indicated in step 8.

In an embodiment of the invention, the cash stamp is used as an advertising tool. An example of such a use is where a car dealership wishes to conduct an email-based advertising campaign to a qualified list of 200 consumers. Here, in order to increase the responsiveness of the consumers to the email advertisement, the car dealership is willing to pay the consumers $1.00 for viewing the advertisement. As a result, the car dealership purchases 200 cash stamps from the Stamps Clearinghouse, where $205 is prepaid for the cash stamps, whether they are redeemed or not, and the payment includes a $5 processing fee. Once the cash stamps are received from the Stamps Clearinghouse, the car dealership attaches the cash stamps to the email advertisements and forwards them to the consumers. The attachment of the cash stamps to the email is achieved in a manner that a person skilled in the art would readily appreciate.

With respect to the consumer, in the case where the consumer's ISP has a relationship with the Stamps Clearinghouse, the ISP validates the cash stamp and delivers the email to the consumer. Once the consumer opens the email and the ISP receives notification that the email has been opened, such as via a Read-Receipt function, the ISP redeems the cash stamp at the Stamps Clearinghouse and credits the consumer's account at the ISP for $1. (In this case, the consumer is not charged a fee by the ISP, the Stamps Clearinghouse, or the business for facilitating redemption because the consumer has an ISP that has a relationship with the Stamps Clearinghouse.) If the consumer's ISP does not have a relationship with the Stamps Clearinghouse, the consumer may directly register with the Stamps Clearinghouse to redeem the cash stamp for cash.

In another embodiment of the invention, the cash stamps are used to increase website traffic. An example of such a use is where businesses use a combination of cash stamps with different required activities so as to facilitate a rich interaction with consumers, and to motivate consumers to read their email advertisements. For example, a car dealership wishing to conduct an email-based advertising campaign purchases 200 $1 cash stamps having an expiration date of one week from the date of purchase, and 200 $5 cash stamps that require the viewing of a website and registration for an email newsletter. Once a consumer receives and opens the email with the attached cash stamps and conditions for redemption, the consumer's ISP credits the consumer's account with $1 dollar. After the consumer visits the car dealer's website and registers for the email newsletter, the business notifies the Stamps Clearinghouse that the cash stamp are redeemable for cash. The Stamps Clearinghouse notifies the ISP which redeems the cash stamp by depositing the $5 in the consumer's account and notifying the consumer via email of the deposit.

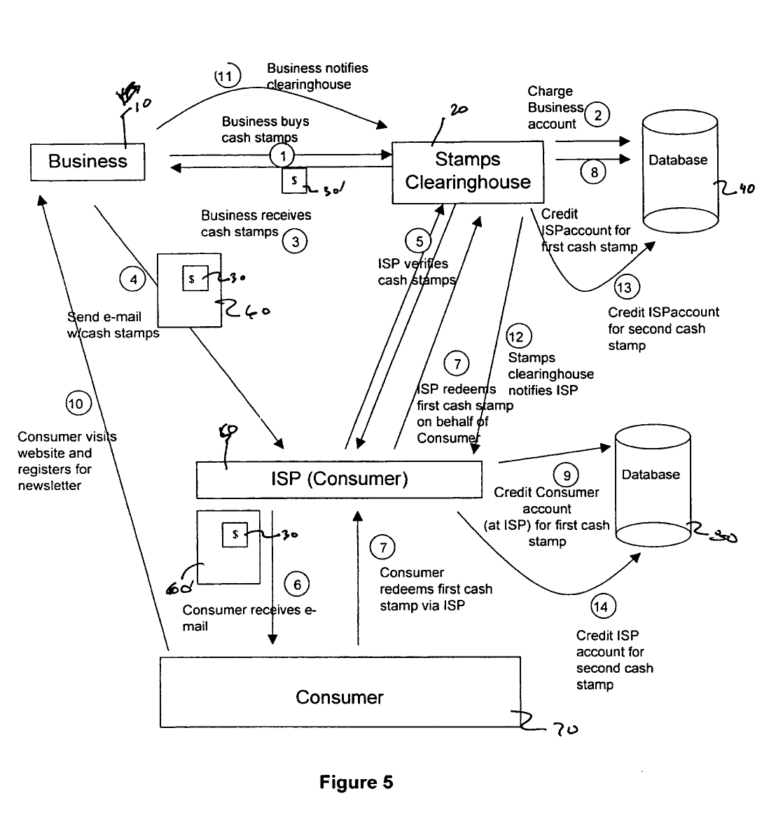

FIG. 5 is a block diagram illustrating the entities involved when a consumer is sent two cash stamps with two separate activities required. With further reference to FIG. 5, the method of the present embodiment is implemented when a business 10 accesses the Stamps Clearinghouse 20 to purchase multiple cash stamps 30′, as indicated in step 1. The Stamps Clearinghouse 20 charges the business' account that is located in the database 40 for the value of the cash stamps 30′, as indicated in step 2. Next, the Stamps Clearinghouse 20 sends the cash stamps 30′ to the business 10, as indicated in step 3. The business 10 attaches the cash stamps 30′ to an email 60 and forwards the email containing the cash stamps 30′ to the consumer's ISP 50, as indicated in step 4. In the preferred embodiment of the invention, the business is an advertiser, and two cash stamps are purchased, where the first cash stamp requires the opening of an email and the second cash stamp requires the consumer to visit a webpage and register for an email newsletter.

After receiving the cash stamps 30′, the ISP 50 verifies that the attached stamps are valid, as indicated in step 5. In an embodiment, the Stamps Clearinghouse also verifies that the entity which created the attached cash stamp is identical to the sender of the e-mail message. As a result, the prevention of “spoofing” is achieved, i.e. a type of e-mail fraud where the sender exploits limitations of e-mail systems so as to make it appear that the e-mail originates from another sender. Next, the ISP 50 “flags” the email 60 as containing cash stamps 30′, and forwards them to the consumer 70, as indicated in step 6.

When the consumer 70 opens the email, the ISP 50 is notified that the consumer has read the email, and a cash stamp is redeemed at the Stamps Clearinghouse 20, as indicated in step 7. In the preferred embodiment, the first cash stamp is redeemed.

The Stamps Clearinghouse 20 credits the value of the redeemed cash stamp to the consumers ISP account that is located in database 40 at the Stamps Clearinghouse 20, as indicated in step 8. The ISP 50 also credits the value of the redeemed cash stamp to the consumer's account that is located in database 80 at the ISP 50, as indicated in step 9.

Next, the consumer 70 visits the business' website (not shown) and registers for an email newsletter to thereby complete the requirements for redeeming the cash stamp, as indicated in step 10. The business 10 notifies the Stamps Clearinghouse 20 that the consumer 70 has completed the required activity for redeeming the cash stamp, as indicated in step 11. Next, the Stamps Clearinghouse 20 notifies the ISP 50 that another cash stamp has been redeemed, as indicated in step 12.

The Stamps Clearinghouse 20 credits the value of the other cash stamp to the ISP account of the consumer that is located in database 40, as indicated in step 13. The ISP also credits the value of the other cash stamp to the consumer's account that is located in database 80, as indicated in step 13. In the preferred embodiment, the other cash stamp is the second cash stamp.

In an alternative embodiment, the cash stamps are used to facilitate payments from a consumer to a business. For example, a software company sells a product for which it offers free customer support via email, but only during the first 3 months after the purchase. Beyond the initial 3 months, the software company requires a payment of $50 per incident. In accordance with the present embodiment, a consumer wishing to request support would be required to purchase a cash stamp worth $50, and attach it to his email that he sends to the email address of the software company's customer support division.

On the receiving end, the software company's mail server checks all emails. Each email that contains a valid $50 cash stamp is allowed to proceed to the incoming mailbox of the customer support team. Note that the software company has the option to automatically cash in the stamps at this stage, even before the email is handled by a customer support representative. Alternatively, the cash stamps are redeemable at a subsequent time at the discretion of the customer representative who will read the email containing the request for support.

In another embodiment, the cash stamps are used by an intermediary entity that handles the email prior to delivery to a final destination. In an exemplary embodiment of the present invention, the cash stamps are used to ensure the quality of email service. For example, email is used as a primary mode of communication between individuals, as well as businesses. However, in most cases, no guarantees are made concerning delivery of email, nor are emails usually traceable from the moment an email is sent until it is read by the recipient. In accordance with the present embodiment, cash stamps provide a way to ensure payment for increased quality levels of email service from those who request it. In the present contemplated embodiment, the services include: (i) Encryption, where an email is digitally encrypted to protect its contents from being viewed by unauthorized entities; (ii) Authentication, where an outgoing email is digitally signed with the identity of the sender as a way of guaranteeing to the receiver the source of the email, as well as ensuring the sender warrants his email, i.e. cannot deny having sent that email; (iii) Registered email; and (iv) Certified email. Registered mail is analogous to the US Post-Office registered mails system, i.e. an official acknowledgment that an email was processed for transmittal; and (iv) Certified email. Certified email is analogous to the US Post-Office certified mail system, i.e. a complete record of the history of the email is established from the sender to the receiver. In the “Certified” case, there is an expectation; in that, the attached cash stamps will be cashed-in by the sender's ISP, the recipient ISP, and/or any other intermediaries prior to the email arriving at its final destination. As a result, when the consumer receives the email, the cash stamp is no longer attached.

In another embodiment of the invention, the cash stamps are used in the context of messages. However, in alternative embodiments of the invention, the cash stamps are not limited to being used in email messages. Here, the cash stamps are used in any context where an electronic device, connected via the Internet to the Stamps Clearinghouse, can validate cash stamps in real-time. In the preferred embodiment, the cash stamps are used in a web-site containing advertising, cell-phone-based micro-payments, and/or a cell phone based “wallet.”

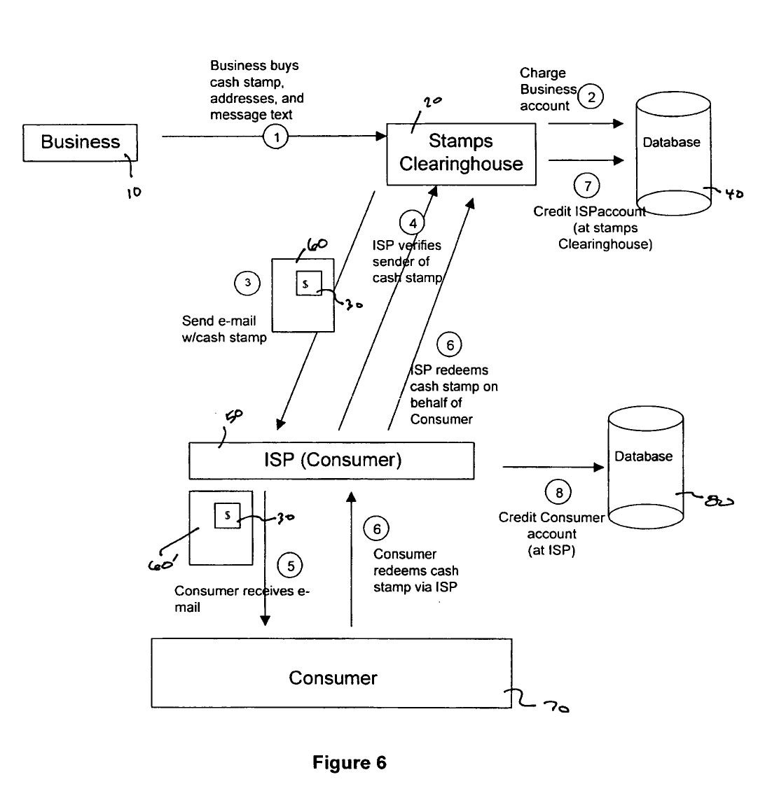

In the embodiments where the web-site contains advertising, the advertiser can “reward” consumers for taking the time to read a set of web pages by way of including a cash stamp in the web page. Here, the consumers can redeem the cash stamp for cash only by performing a “touring test” (i.e. an act only a human can perform). The touring test prevents automated programs from browsing such sites. FIG. 6 is a block diagram illustrating the entities involved during a normal transaction when the consumer's ISP has a relationship with the Stamps Clearinghouse of FIG. 1, and the Stamps Clearinghouse sends an email containing a cash stamp. With reference to FIG. 6, the method of the present embodiment is implemented when a business 10 accesses the Stamps Clearinghouse 20 to purchase a cash stamp 30 and provides the email addresses of consumers and message text to the Stamps Clearinghouse 20, as indicated in step 1. In the preferred embodiment, the business is an advertiser.

The Stamps Clearinghouse 20 charges the business' account located in database 40 for the value of the cash stamp 30, as indicated in step 2. The Stamps Clearinghouse 20 attaches the cash stamp 30 to an email 60 and forwards the email containing the cash stamp to the consumer's ISP 50, as indicated in step 3.

Upon receiving the email 60, the ISP 50 verifies that the email message originated from the Stamps Clearinghouse 20, as indicated in step 4. If the email originated from the Stamps Clearinghouse 20, then it is flagged as containing a cash stamp 30 and forwarded to the consumer 70 by the ISP 50, as indicated in step 5. When the consumer receives the email and opens it, the consumer's ISP 50 is notified that the consumer has read the email and the cash stamp is redeem by the ISP at the Stamps Clearinghouse 20, as indicated in step 6.

The Stamps clearinghouse 20 credits the value of the cash stamp 30 to the consumer's ISP account located in the database 40 at the Stamps Clearinghouse 20, as indicated in step 7. The ISP 50 also applies a credit for the value of the cash stamp 30 to the consumer's account located in the database at the ISP 80, as indicated in step 8.

In embodiments of the invention that utilize cell-phone-based micro-payments, the cash stamp is a string of digital bits, i.e., 1's and 0's. Here, the cash stamp is representable in text form as a hexadecimal word. For example, a 256-bit cash stamp is represented as 64 hexadecimal letters. As a result, a cell-phone customer can purchase a number of cash stamps from the Stamps Clearinghouse and thus, receive SMS or General Packet Radio Services (GPRS) messages containing the corresponding cash stamps in hexadecimal text format. The cash stamps are useable at points-of-sale via an SMS interface after they are sent in an SMS message to the point of-sale providers. Alternatively, when the consumer is equipped with a cell-phone that displays numbers as barcodes, the cash stamps may be displayed as a barcode that is scanned at the point-of-sale, validated, and cash in.

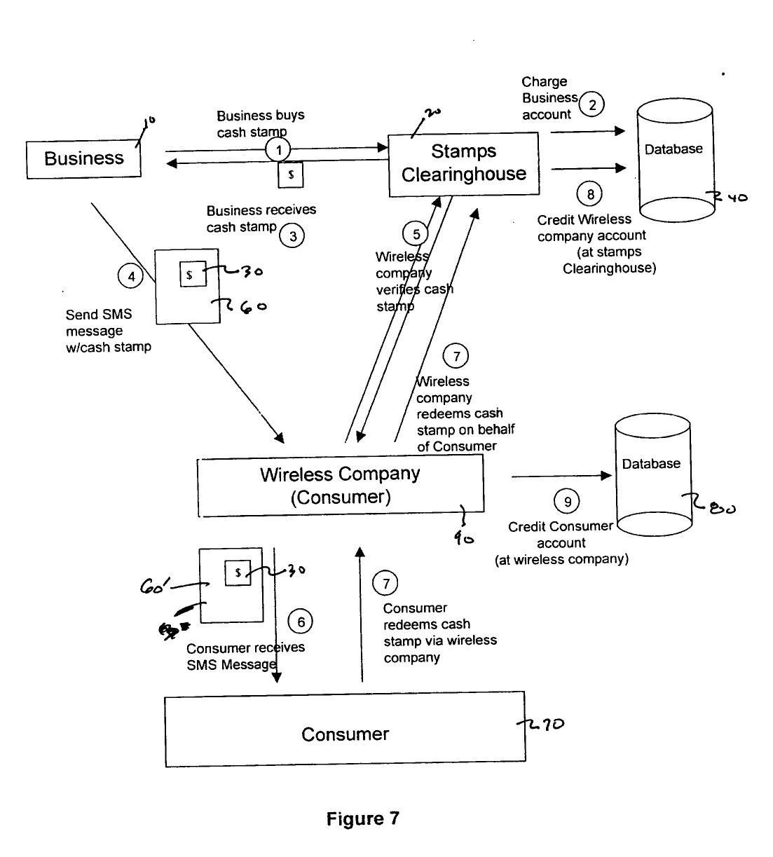

FIG. 7 is a block diagram illustrating the entities involved during a normal transaction utilizing short message service (SMS) messaging when the consumer's wireless company has a relationship with the Stamps Clearinghouse. With reference to FIG. 7, the method of the present embodiment is implemented when a business accesses the Stamps Clearinghouse to purchase a cash stamp. In the preferred embodiment, the business is an advertiser.

The Stamps Clearinghouse 20 charges the business' account that is located in database 40 for the value of the cash stamp 30, as indicated in step 2. Next, the Stamps Clearinghouse 20 forwards the cash stamp 30 to the business 10, as indicated in step 3.

The business 10 attaches the cash stamp 30 to an SMS message 60′ and forwards the message to a wireless company 90, as indicated in step 4. The wireless company performs a query to verify the validity of the cash stamp or that the cash stamp 30 originated from the Stamps Clearinghouse 20, as indicated in step 5. If the cash stamp is valid, then the consumer receives the SMS message 60′ containing the cash stamp 30, as indicated in step 6.

Upon receiving the SMS message, the consumer 70 can redeem the cash stamp via the wireless company 90, where the cash stamp is redeemed by the wireless company 90 at the Stamps Clearinghouse 20 on behalf of the consumer, as indicated in step 7. When the consumer redeems the cash stamp via the wireless company 90, the Stamps Clearinghouse 20 credits the wireless company's account that is located in database 40 with the value of the cash stamp, as indicated in step 8. In addition, the wireless company 90 credits the consumer's account that is located at database 40 with the value of the cash stamp, as indicated in step 9.

In embodiments of the invention where a cell phone based “wallet” is used, an IP-enabled phone or another device, such as a Personal Digital Assistant, may download an application which enables acceptance or issuance of cash stamps and interacts with the Stamps Clearinghouse. As a result, completion of a transaction is achieved/facilitated by sending requests for payment to the Stamps Clearinghouse. In this way, confirmation or acceptance that requests be paid from third party sources is achieved, along with an attachment of a payment for the cash stamp. For example, a consumer in a restaurant can use his cell phone to pay the restaurant by sending an appropriately valued cash stamp to the restaurant's email address. Once the cash stamp is received, the restaurant may receive a confirmation from the Stamps Clearinghouse to indicate that the funds have been transferred. In accordance with the present embodiment, this transaction may be conducted separately from the cell phone company (e.g., where the consumer has an established account at the clearinghouse), or it may be integrated with the cell phone company (e.g., billing for the cash stamp may be integrated with billing for cell phone services).

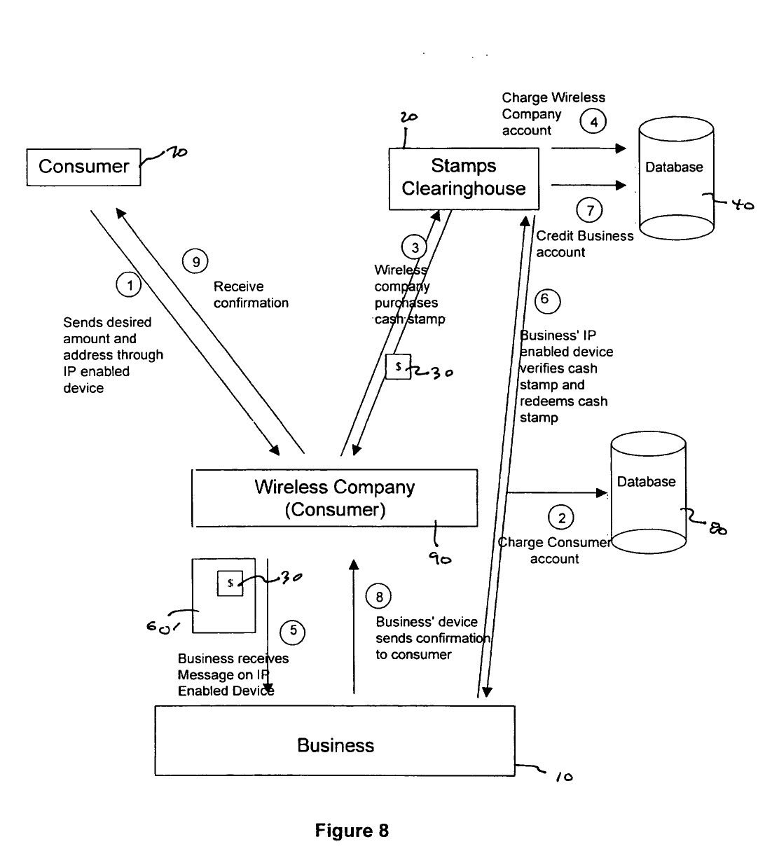

FIG. 8 is a block diagram illustrating the entities involved during a normal transaction from a consumer to a business, conducted through IP enabled phones or the like in accordance with the present embodiment. With specific reference to FIG. 8, the method of the present embodiment is achieved when the consumer 70 sends an account address and a desired amount for a cash stamp 30 to the consumer's wireless company 90, as indicated in step 1.

The database 80 is accessed by the wireless company 90 to bill the consumer's account at their wireless company 90 for the value of the cash stamp 30, as indicated in step 2. Next, the wireless company 90 buys a cash stamp 30 from the Stamps Clearinghouse 20, as indicated in step 3. The Stamps Clearinghouse 20 charges the wireless company 90 for the value of the cash stamp 30, as indicated in step 4.

The wireless company 90 then sends the cash stamp 30 to the business 10 in an email 60, as indicated in step 5. Here, the business' IP enabled device (not shown) confirms the validity of the cash stamp 30 and redeems it at the Stamps Clearinghouse 20, as indicated in step 6.

After redemption of the cash stamp 30, the Stamps Clearinghouse 20 credits the account of the business which is stored in the database 40, as indicated in step 7. The business' IP enabled device (not shown) sends a confirmation message to the wireless company 90, as indicated in step 8. The consumer 10 receives a confirmation message of the transaction, as indicated in step 9.

The system and method of the present invention provides multiple benefits to various users. Businesses gain the attention of consumers due to the desire of consumers to be compensated for their attention to each specific business. In addition, businesses are able to differentiate between the amounts paid to different consumers, potentially having a greater impact on the most valuable consumers. The businesses are able to motivate consumers to perform a certain activity, providing an enriched interaction with the business. On the other hand, the consumers get paid for the attention that they provide to potentially simple activities. The consumers are also guaranteed to receive payments from a trustworthy source. In addition, the consumers are able to differentiate between commercial emails based on the amount each business is willing to pay for viewing their email. ISPs provide value-added services to the consumer. The potential to earn a fee for facilitating delivery and redemption of cash stamps is also provided, along with the potential to receive the value of cash stamps that are redeemed from consumers for the ISP's service or for premium rate services offered by the ISP. Finally, the Stamps Clearinghouse is provided with the potential to earn income from businesses, ISPs, and consumers for facilitating cash payments.

Although the invention has been described and illustrated in detail, it is to be clearly understood that the same is by way of illustration and example, and is not to be taken by way of limitation. The spirit and scope of the present invention are to be limited only by the terms of the appended claims.

1. A method for creating, distributing, tracking and redeeming payments to a consumer, comprising the steps of:
accessing a first entity to request a cash stamp having a value;
forwarding the requested cash stamp to a business;
attaching the cash stamp to an email message; and
distributing the email message containing the cash stamp to a consumer.

2. The method of claim 1, wherein said forwarding step includes the step of:
charging an account of the business for the value of the cash stamp prior to forwarding the cash stamp to the business.

3. The method of claim 1, wherein said distributing step includes the step of:
sending the email to a second entity that is associated with the consumer.

4. The method of claim 3, wherein the second entity is one of an ISP or a wireless provider.

5. The method of claim 4, further comprising the step of:
querying the first entity to determine whether the attached cash stamp is valid; and
flagging the email to provide an indication to the consumer that the cash stamp is valid.

6. The method of claim 5, wherein said querying step includes the step of:
verifying that the first entity which forwarded the attached cash stamp to the business is the identical to the sender of the email message.

7. The method of claim 5, further comprising the step of:
notifying the ISP that the flagged email has been read when the consumer opens the flagged email.

8. The method of claim 1, further comprising the step of:
crediting the value of the cash stamp to at least one of a consumer's accounts when the cash stamp is redeemed by the consumer.

9. The method of claim 8, wherein the consumer has an account at the first entity and a second entity.

10. The method of claim 1, wherein the first entity is a Stamps Clearinghouse and the second entity is an ISP or a wireless service provider.

11. The method of claim 5, wherein said querying step is performed by the second entity.

12. The method of claim 7, wherein said querying step comprises the step of:
sending a validation reply from the first entity to the consumer in response to a query performed by the consumer.

13. The method of claim 1, further comprising the step of:
sending a plurality of cash stamps to the business.

14. The method of claim 13, wherein the plurality of cash stamps comprises a first and a second cash stamp each having a cash value.

15. The method of claim 14, wherein the first cash stamp includes a requirement for the consumer to open the email, and the second cash stamp requires the consumer to visit a web site and register for an email newsletter.

16. The method of claim 15, further comprising the steps of crediting the fixed cash value of the first cash stamp to an account belonging to the consumer when the consumer opens the first email; and
crediting the cash value of the second cash stamp when the consumer visit the web site and registers for the email newsletter.

17. The method of claim 1, wherein the cash stamp has a value that is fixed, or 2 declines after a fixed period of time.

18. The method of claim 1, wherein the cash stamps are redeemable for at least one of cash, consumer goods, services, or discounts on consumer good and services.

19. A system for creating, distributing, tracking and redeeming payments to a consumer, comprising:
a first entity for providing cash stamps in response to a request from a business; and
a second entity for receiving cash stamps which are forwarded from the business or the first entity; said first entity and the second entity having an associated database for storing account information.

20. The system as set forth in claim 19, wherein the first entity is a Stamps Clearinghouse and the second entity is an ISP or a wireless provider.

21. The system as set forth in claim 20, wherein the Stamps Clearinghouse charges an account of the business for a value of the cash stamp prior to forwarding the cash stamp to the business.

22. The system of claim 22, wherein the ISP queries the Stamps Clearinghouse to determine whether the attached cash stamp is valid.

23. The system of claim 20, wherein the Stamps Clearing house credits a value assigned to the cash stamp to at least one of a consumers accounts when the cash stamp is redeemed by the consumer.
